(19) United States
(12) Patent Application Publication
(10) Pub. No.: US 2026/0222173 A1
(43) Pub. Date: Jul. 30, 2026

(54) ELECTRONIC DEVICE FOR PERFORMING DISTRIBUTED OPERATION, AND METHOD FOR CONTROLLING SAME

(71) Applicants: CRYPTO LAB INC., Seoul (KR); SEOUL NATIONAL UNIVERSITY R&DB FOUNDATION, Seoul (KR)

(72) Inventors: Jungho Ahn, Seoul (KR); Jongmin Kim, Seoul (KR); Sangpyo Kim, Seoul (KR); Wonkyung Jung, Seoul (KR)

(21) Appl. No.: 19/144,351

(22) PCT Filed: Dec. 30, 2022
(86) PCT No.: PCT/KR2022/021756

§ 371 Date: Jun. 27, 2025

(51) Int. Cl. H04L 9/00

(52) U.S. Cl. CPC H04L 9/008

(57) ABSTRACT

An electronic apparatus for performing a distributed operation, and a method for controlling same are disclosed. The method for controlling the electronic apparatus comprises the steps of: allocating an index to each coefficient of a polynomial; converting the index allocated to each coefficient into a mapping index corresponding to multiple processors; transferring the coefficient to each of the corresponding multiple processors based on the converted mapping index; and performing, by the multiple processors, an operation based on the transferred coefficient.

### TECHNICAL FIELD

Apparatuses and methods consistent with the disclosure relate to an electronic apparatus for performing a distributed operation and a method for controlling the same, and more particularly, to an electronic apparatus for performing a homomorphic encryption operation in a distributed manner and a method for controlling the same.

### BACKGROUND ART

Homomorphic encryption is a post-quantum encryption technique, and research for commercialization is actively being conducted because it allows operations in an encrypted state. The biggest problem in the process of commercializing homomorphic encryption is that high computational complexity of the homomorphic encryption operation increases a computation time. For example, the complexity of the homomorphic encryption operation may increase by about 10 to 10,000 times compared to operations on unencrypted data.

Therefore, there is a need for a distributed operation method capable of shortening a computation time of homomorphic encryption.

### DISCLOSURE OF INVENTION

### Technical Problem

The present disclosure is to efficiently perform a homomorphic encryption operation through a distributed operation.

### Solution to Problem

In accordance with an aspect of the disclosure, a method for controlling an electronic apparatus for performing a distributed operation includes: allocating an index to each coefficient of a polynomial; converting the index allocated to each coefficient into a mapping index corresponding to multiple processors; transferring the coefficient to each of the corresponding multiple processors based on the converted mapping index; and performing, by the multiple processors, an operation based on the transferred coefficient.

In the converting of the index into the mapping index, the index allocated to the coefficient may be converted into the mapping index based on a remainder value of a result of a modulo operation for the index allocated to the coefficient according to a preset rotation count and the number of coefficients.

In the converting of the index into the mapping index, a value expressed as a bit-reversed value of the index allocated to the coefficient may be determined as the mapping index.

In the transferring, the multiple processors are arranged in an n-dimension including n axes, the coefficient may be temporarily transferred to each of the multiple processors based on a first component and a first axis of coordinates of the mapping index, and the coefficient transferred to each of the multiple processors may be finally transferred to each of the multiple processors based on an n-th component and an n-th axis of the coordinates of the mapping index.

The method may further include: determining an address of the coefficient based on a first memory space whose start address is a first offset; determining a storage address of a second memory space whose start address is a second offset based on the determined address and the converted mapping index; and storing the coefficient in the determined storage address of the second memory space.

The polynomial may include a first polynomial and a second polynomial to perform an operation.

In the operating, an operation between coefficients whose mapping index of a coefficient included in the first polynomial and mapping index of a coefficient included in the second polynomial are the same may be performed.

In accordance with another aspect of the disclosure, an electronic apparatus includes: a memory; and a processor, in which the processor is configured to allocate an index to each coefficient of a polynomial stored in the memory, convert the index allocated to each coefficient into a mapping index corresponding to multiple processors, transfer the coefficient to each of the corresponding multiple processors based on the converted mapping index, and allow the multiple processors to perform an operation based on the transferred coefficient.

The processor may be configured to convert the index allocated to the coefficient into the mapping index based on a remainder value of a result of a modulo operation for the index allocated to the coefficient according to a preset rotation count and the number of coefficients.

The processor may be configured to determine a value expressed as a bit-reversed value of the index allocated to the coefficient as the mapping index.

The processor may be configured to allow the multiple processors to be arranged in an n-dimension including n axes, temporarily transfer the coefficient to each of the multiple processors based on a first component and a first axis of coordinates of the mapping index, and finally transfer the coefficient transferred to each of the multiple processors to each of the multiple processors based on an n-th component and an n-th axis of the coordinates of the mapping index.

The processor may be configured to determine an address of the coefficient based on a first memory space whose start address is a first offset, determine a storage address of a second memory space whose start address is a second offset based on the determined address and the converted mapping index, and store the coefficient in the determined storage address of the second memory space.

The polynomial may include a first polynomial and a second polynomial to perform an operation.

The processor may be configured to perform an operation between coefficients whose mapping index of a coefficient included in the first polynomial and mapping index of a coefficient included in the second polynomial are the same.

In accordance with still another aspect of the disclosure, there is provided a non-transitory computer-readable storage medium on which a program for executing a method for controlling an electronic apparatus is recorded, in which the program includes: allocating an index to each coefficient of a polynomial; converting the index allocated to each coefficient into a mapping index corresponding to multiple processors; transferring the coefficient to each of the corresponding multiple processors based on the converted mapping index; and performing, by the multiple processors, an operation based on the transferred coefficient.

### Effect of Invention

According to the present disclosure, it is possible to efficiently perform a homomorphic encryption operation through a distributed operation.

The effects of the present disclosure are not limited to the above-described effects, and other effects that are not mentioned may be obviously understood by those skilled in the art from the following description.

### BRIEF DESCRIPTION OF DRAWINGS

FIG. 1 is a diagram for describing a configuration of an electronic apparatus according to an embodiment of the present disclosure.

FIG. 2 is a diagram for describing a specific configuration of the electronic apparatus according to an embodiment of the present disclosure.

FIG. 3 is a diagram for describing a process of obtaining a mapping index using a modulo operation according to an embodiment of the present disclosure.

FIG. 4 is a diagram for describing a process of obtaining a mapping index using a bit reverse method according to an embodiment of the present disclosure.

FIGS. 5 to 7 are diagrams for describing a method for allocating a coefficient to a two-dimensionally arranged processor according to an embodiment of the present disclosure.

FIGS. 8 to 10 are diagrams for describing a method for allocating a coefficient to a three-dimensionally arranged processor according to an embodiment of the present disclosure.

FIG. 11 is a diagram for describing a method for controlling an electronic apparatus according to an embodiment of the present disclosure.

### MODE FOR INVENTION

Hereinafter, various embodiments will be described in more detail with reference to the accompanying drawings. Embodiments mentioned in the specification may be variously modified. A specific embodiment may be illustrated in the drawings and be described in detail in a detailed description. However, the specific embodiment illustrated in the accompanying drawings is provided only to allow various embodiments to be easily understood. Therefore, it should be understood that the spirit of the present disclosure is not limited by the specific exemplary embodiment illustrated in the accompanying drawings, but includes all the modifications, equivalents, and substitutions included in the spirit and the scope of the present disclosure.

Terms including ordinal numbers such as “first”, “second”, and the like, may be used to describe various components. However, these components are not limited by these terms. These terms are used only to distinguish one component from another component.

It should be further understood that terms “include” or “have” used in the present specification specify the presence of features, numerals, steps, operations, components, parts described in this specification, or combinations thereof, but do not preclude the presence or addition of one or more other features, numerals, steps, operations, components, parts, or combinations thereof. It is to be understood that when one component is referred to as being “connected to” or “coupled to” another component, one component may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween.

Meanwhile, a term “module” or “~er/~or” for components used in the present specification performs at least one function or operation. In addition, a “module” or a “~er/~or” may perform a function or an operation by hardware, software, or a combination of hardware and software. In addition, a plurality of “modules” or a plurality of “~ers/~ors” except for a “module” or a “~er/~or” performed by specific hardware or performed by at least one processor may be integrated in at least one module. Singular forms include plural forms unless the context clearly indicates otherwise.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B. In addition, in the present specification, the term “include” has a meaning encompassing further including other components in addition to elements listed as included.

In the present specification, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In addition, in describing the present disclosure, when it is decided that a detailed description for the known functions or configurations related to the present disclosure may unnecessarily obscure the gist of the present disclosure, the detailed description therefor will be omitted. Meanwhile, each embodiment may be implemented or operated independently, but each embodiment may be implemented or operated in combination.

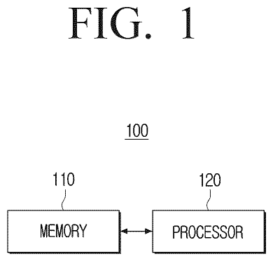

FIG. 1 is a diagram for describing a configuration of an electronic apparatus according to an embodiment of the present disclosure.

Referring to FIG. 1, the electronic apparatus 100 may include a memory 110 and a processor 120.

The memory 110 may store data, algorithms, and the like that perform functions of the electronic apparatus 100, and store programs, commands, and the like that run on the electronic apparatus 100. In addition, the memory 110 may store a polynomial that performs a homomorphic encryption operation. In addition, the memory 110 may store an operation result of operating the polynomial.

The processor 120 may control each component of the electronic apparatus 100. For example, the processor 120 may control the memory 110 to load a homomorphically encrypted polynomial (or coefficients of the polynomial) stored in the memory 110 and store the operation result. The electronic apparatus 100 may include one or more processors 120.

The processor 120 may allocate an index to each coefficient of the polynomial stored in the memory 110. For example, the processor 120 may sequentially allocate an index starting from the coefficient of the highest or lowest order term of the polynomial. Alternatively, the processor 120 may consider multiple processors as arranged in N dimensions instead of one dimension, and may allocate an index including multiple coordinate components to the coefficients of the polynomial based on the processors arranged in N dimensions.

The processor 120 may convert indexes allocated to each coefficient into mapping indexes corresponding to the multiple processors. The mapping index may be an indicator that identifies a final processor that will perform the operation on the current coefficient. For example, the processor 120 may convert the current index into the mapping index using a modulo operation. The processor 120 may convert the index allocated to the coefficient into the mapping index based on the remainder value of the result of the modulo operation for the index allocated to the coefficient according to the preset rotation count and the number of coefficients. Alternatively, the processor 120 may determine a value expressed as a reciprocal of bits of the index allocated to the coefficient as the mapping index. A specific example of converting to the mapping index is described later.

The processor 120 may transfer the coefficients to each of the corresponding multiple processors based on the converted mapping index. In the present disclosure, the processor 120 may be included in the multiple processors performing a distributed operation. In this case, one of the multiple processors may perform a process for transferring the coefficients to each processor and an operation on the allocated coefficients. Alternatively, the processor 120 may be a separate processor other than the multiple processors performing the distributed operation.

The processor 120 may perform an operation based on the coefficients transferred by the multiple processors. For example, the operation of the present disclosure is an operation performed in a homomorphic encrypted state and may include multiplication or addition. The polynomial may include a first polynomial and a second polynomial on which the operation is to be performed. The processor 120 may perform an operation between coefficients whose mapping index of the coefficient included in the first polynomial and mapping index of the coefficient included in the second polynomial are the same. The homomorphic encryption may perform an operation between coefficients whose indexes are the same. Therefore, the processor 120 transfers the coefficient of the first polynomial and the coefficient of the second polynomial, which include the same index, to the same processor, and the processor that has received the coefficient of the first polynomial and the coefficient of the second polynomial may perform the homomorphic encryption operation.

The present disclosure describes an example of allocating the coefficients of the polynomial to the multiple processors and performing an operation, but is not limited to the description of the present disclosure. For example, the processor 120 described in the present disclosure may be a core or an electronic apparatus. That is, the processor 120 transfers the coefficients of the polynomial to multiple cores included in the processor 120 based on the mapping index, and each core may calculate the coefficients of the polynomial that have been received. Alternatively, the electronic apparatus 100 may transfer the coefficients of the polynomial to a plurality of external electronic apparatus based on the mapping index, and each external electronic apparatus may calculate the received coefficients of the polynomial.

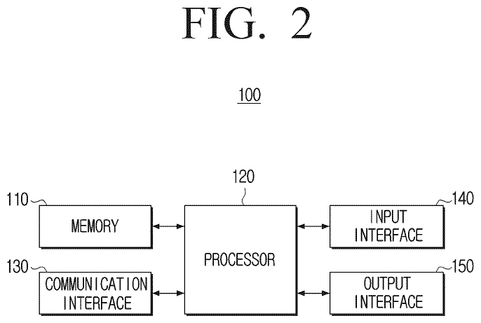

FIG. 2 is a diagram for describing a specific configuration of the electronic apparatus according to an embodiment of the present disclosure.

Referring to FIG. 2, the electronic apparatus 100 may include the memory 110, the processor 120, a communication interface 130, an input interface 140, and an output interface 150. The memory 110 may be the same as described in FIG. 1.

The communication interface 130 may perform communication with an external electronic apparatus. The communication interface 130 may receive or transmit homomorphically encrypted data from an external electronic apparatus. The electronic apparatus 100 may store homomorphically encrypted data received from the external electronic apparatus in the memory 110. For example, when the electronic apparatus 100 performs a distributed operation using multiple external electronic apparatus, the electronic apparatus 100 may transfer a polynomial (or the coefficients of the polynomial) to the external electronic apparatus and receive the calculated result. The communication interface 130 may communicate with the external device using at least one of the following communication methods: Wi-Fi, Wi-Fi direct, Bluetooth, Zigbee, 3rd Generation (3G), 3rd Generation Partnership Project (3GPP), and Long Term Evolution (LTE). The communication interface 130 may be referred to as a communication device, a communication unit, a communication module, a transceiver, etc.

The input interface 140 may receive control commands from the user. For example, the input interface 140 may include a keyboard, buttons, a key pad, a touch pad, and a touch screen. Alternatively, the input interface 140 may be implemented as an input/output port. In this case, the input interface 140 may be called an input/output interface. When the input interface 140 is implemented as an input/output port, the input/output ports include High-Definition Multimedia Interface (HDMI), DisplayPort (DP), RGB, Digital Visual Interface (DVI), Universal Serial Bus (USB), Thunderbolt, audio jacks, video jacks, etc. In addition, the input interface 140 may receive or output homomorphically encrypted data. The input interface 140 may be called an input device, an input unit, an input module, etc., and when implemented as the input/output port, the input interface 140 may be called an input/output device, an input/output unit, an input/output module, etc.

The output interface 150 may output data processed by the processor 120. For example, the output interface 150 may include a speaker and a display. The speaker may output the processed data as a sound signal. The display may output data processed by the processor 120 as an image. For example, the display may be implemented as a liquid crystal display (LCD), an organic light emitting diode (OLED), a flexible display, a touch screen, etc. When the display is implemented as the touch screen, the electronic apparatus 100 may receive control commands through the touch screen.

The electronic apparatus 100 may include all of the above-described components or may include some of the components.

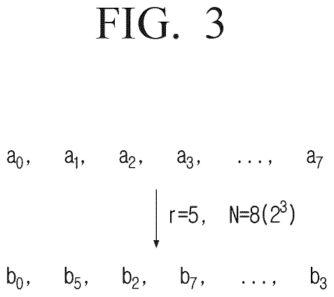

FIG. 3 is a diagram for describing a process of obtaining a mapping index using a modulo operation according to an embodiment of the present disclosure.

Referring to FIG. 3, coefficients a₀, a₁, a₂, . . . , a₇ of a polynomial to which an index is allocated are illustrated. In an embodiment, the number of coefficients (N) of the polynomial is 8, and each may be allocated an index (i) from 0 to 7. The electronic apparatus 100 may convert the index allocated to the coefficient into the mapping index based on the remainder value of the result of the modulo operation for the preset rotation count and the index allocated to the coefficient.

In an embodiment, when the number N of coefficients of the polynomial is 8, and the electronic apparatus 100 rotates 5 times, the electronic apparatus 100 may perform a (modulo 8) operation based on the index of each coefficient and the rotation count of 5 times. The electronic apparatus 100 may obtain the conversion index of the index allocated to each coefficient using the Equation of (i×r) mod N. That is, a conversion index of the index 0 may be 0 (the remainder of dividing (0×5) by 8), and the conversion index of the index 1 may be 5 (the remainder of dividing (1×5) by 8). The electronic apparatus 100 may obtain the conversion index of index 2 as 2, the conversion index of index 3 as 7, and the conversion index of index 7 as 3 in the above-described manner.

The electronic apparatus 100 may transfer the coefficient of the polynomial to one (or core, external device) of the multiple processors based on the conversion index. That is, as illustrated in FIG. 3, a₀ may be transferred to b₀, and a₁ may be transferred to b₅. The coefficients of a₀ to a₇ may be transferred to each of the eight processors in the above-described manner. a and b may mean that they are the same coefficients with changed indexes.

The method of obtaining the conversion index described above does not have overlapping conversion indexes because the conversion index is obtained based on the number of coefficients and the remainder of the polynomial. Therefore, one coefficient may be transferred to each processor.

The above-described process is described mathematically as follows.

An N−1 degree polynomial f(x), which is an element of a polynomial ring R, may be expressed as a vector f with N coefficients as elements, as follows:

$$f ( x ) = {a}_{0} + {a}_{1} \cdot x + {a}_{2} \cdot {x}^{2} + … + {a}_{N - 1} \cdot {x}^{N - 1} ∈ R$$

$$f = ( {a}_{0} , {a}_{1} , {a}_{2} , … , {a}_{N - 1} ) ∈ {Z}^{N}$$

$$f ( x ) ⇔ f$$

Here, a₀, a₁, a₂, . . . , a_{N-1} are coefficients of this polynomial, which are elements of the coefficient set Z. f(x)⇔f may mean that the polynomial f(x), which is an element of the polynomial ring, and the vector f, which is an element of Z^{N}, are equivalent.

For example, when Z is a set of integers, f may be a vector composed of N integers, and when Z is composed of vectors, f may be a matrix or tensor composed of N vectors. For the vector f in the above Equation, an i-th element of the vector may be represented as f[i], and i may be called the index of f[i].

$$f [ i ] = {a}_{i} ∈ Z ( i = 0 , 1 , … , N - 1 )$$

The automorphism or applied to the polynomial f(x) is fᵣ(x)=f(x^{r}) as follows.

$${σ}_{r} ( f ( x ) ) = {f}_{r} ( x ) = f ( {x}^{r} ) = {a}_{0} + {sgn}_{N} ( r ) \cdot {a}_{1} \cdot {x}^{[ r ] N} + {sgn}_{N} ( 2 r ) \cdot {a}_{2} \cdot {x}^{[ 2 r ] N} + … + {sgn}_{N} ( ( N - 1 ) r ) \cdot {a}_{N - 1} \cdot {x}^{[ ( N - 1 ) r ] N} ∈ R$$

$${[ t ]}_{N} = ( t mod N ) ∈ [ 0 , N - 1 ]$$

$${sgn}_{N} ( t ) = 1 , {if [ t ]}_{2 N} < N$$

$$- 1 , {if [ t ]}_{2 N} \geq N$$

Here, [t]_{N} is an operation that takes modulo N for integer t, which is equivalent to dividing integer t by integer N and finding the remainder in the range 0 to N−1. The sgn_{N}(t) function finds modulo 2N, [t]_{2N}, for integer t, and has a value of −1 if the value is greater than or equal to N, and a value of 1 if it is less than N, and may be called a sign function. For example, in the above example, the remainder sgn_{N}(t) of (1×5) divided by 8 for index 1 may be 1, and the remainder sgn_{N}(t) of (3×5) divided by 8 for index 3 may be −1.

In this case, when the terms of the automorphism result are sorted in ascending order of the degree of x, they are as follows.

$${f}_{r} ( x ) = f ( {x}^{r} ) = {a}_{0} + {sgn}_{N} ( {[ {r}^{- 1} ]}_{N} \cdot r ) \cdot {a}_{\text{?}} {x}^{1} + {sgn}_{N} ( {[ 2 \cdot {r}^{- 1} ]}_{N} \cdot r ) \cdot {a}_{\text{?}} {x}^{2} + … + {sgn}_{N} ( {[ ( N - 1 ) \cdot {r}^{- 1} ]}_{N} \cdot r \cdot {a}_{\text{?}} {x}^{N - 1} ∈ R$$

$$\text{?} \text{indicates text missing or illegible when filed}$$

If the polynomial fr(x) above is replaced with fᵣ in vector form, it becomes as follows.

$${f}_{r} = \text{?}$$

$${f}_{r} ( x ) ⇔ {f}_{r}$$

$$\text{?} \text{indicates text missing or illegible when filed}$$

It may also be expressed more simply as follows and interpreted that the resulting vector fᵣ is derived by applying the automorphism or to the vector f.

$${σ}_{r} ( f ) = f ( r )$$

A type of Fourier transform such as Number Theoretic Transform (NTT) or Discrete Galois Transform (DGT) may be used to facilitate the multiplication between polynomials included in such a polynomial ring.

For example, the multiplication of polynomials using the NTT may be performed as follows.

$$NTT : {Z}^{N} -> {Z}^{N} , i NTT : {Z}^{N} -> {Z}^{N}$$

$$f ( x ) , g ( x ) ∈ R , f , g ∈ {Z}^{N} , f ( x ) ⇔ f , g ( x ) ⇔ g$$

$${f}_{NTT} = N T T ( f ) , {g}_{NTT} = NTT ( g ) ∈ {Z}^{N}$$

$$f ( x ) \times g ( x ) ⇔ iNTT ( {f}_{N T T} ⊙ {g}_{N T T} )$$

Here, iNTT denotes the inverse Number Theoretic Transform that is a reverse process of NTT. Symbol ⊙ denotes the Hadamard multiplication between Z^{N} elements, and the Hadamard multiplication denotes the multiplication of elements with the same index in two vectors belonging to Z^{N} using the multiplication defined in Z. The result f(x)×g(x) of the multiplication of the polynomials f(x) and g (x) may obtain vectors fNTT and gNTT, which are the results of applying the NTT operation to vectors f and g, which are equivalent vectors to f(x) and g (x), respectively, and may be equivalent to the vector obtained by performing a Hadamard multiplication between fNTT and gNTT and then applying iNTT.

In this case, in order to reduce the number of NTT and iNTT operations, the automorphism operation may be applied to the vectors to which the NTT is applied.

$${τ}_{r} : {Z}^{N} -> {Z}^{N}$$

$${f}_{NTT} = ( {a}_{0} , {a}_{1} , … , {a}_{N - 1} )$$

$${τ}_{r} ( {f}_{NTT} ) = ( {a}_{\text{?}} , {a}_{\text{?}} , … , {a}_{\text{?}} )$$

$$\text{?} \text{indicates text missing or illegible when filed}$$

That is, the automorphism may be expressed as Tr for any odd integer r as in the above Equation.

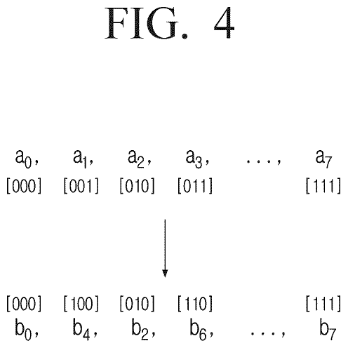

FIG. 4 is a diagram for describing a process of obtaining a mapping index using a bit reverse method according to an embodiment of the present disclosure.

Referring to FIG. 4, coefficients a₀, a₁, a₂, a₃, . . . , a₇ to which indexes are allocated are illustrated. The electronic apparatus 100 may identify the index of each coefficient as a bit. The electronic apparatus 100 may convert (reverse) the identified index into a bit-reversed value. That is, may be converted into [100], and may be converted into [110]. The decimal representation of may be 1, the decimal representation of may be 4, the decimal representation of may be 3, and the decimal representation of may be 6. That is, the electronic apparatus 100 may convert the index 1 into the mapping index 4, and the index 3 may be converted into the mapping index 6.

When the electronic apparatus 100 determines that multiple processors are arranged in a line (one dimension), it may allocate a coefficient to each processor based on the converted mapping index. The electronic apparatus 100 may recognize the multiple processors as being arranged in multiple dimensions. The processors arranged in multiple dimensions may be physically arranged in multiple dimensions, and may be physically arranged in a line (one dimension) or a plane (two dimensions), but may be recognized by the electronic apparatus 100 as being arranged in multiple dimensions of two or more dimensions. For example, the multiple processors may be arranged in the shape of a line, a mesh, a torus, a cube, a hypercube, a flattened butterfly, etc.

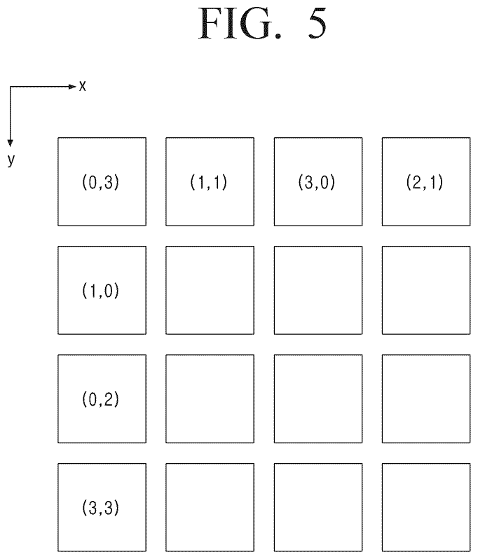

FIGS. 5 to 7 are diagrams for describing a method for allocating coefficients to a two-dimensionally arranged processor according to an embodiment of the present disclosure.

When the electronic apparatus 100 recognizes that multiple processors are arranged in two or more dimensions, the electronic apparatus 100 may obtain coordinate components based on a mapping index. As an example, when 16 processors are arranged in one dimension, the electronic apparatus 100 can sequentially transfer coefficients from mapping indexes 0 to 15 to each of the 16 processors. When 16 processors are arranged in a two-dimensional form of a 4×4 matrix, the electronic apparatus 100 may match the coordinates of the processors of (0, 1), (0, 2), (0, 3), and (0, 4) to the coefficients of the mapping indexes 0 to 4. The electronic apparatus 100 may match the coordinates of the processors in the same manner for the remaining mapping indexes. The above-described example is an embodiment, and the method of matching the coordinates to the mapping indexes may be set in various ways.

The electronic apparatus 100 may arrange multiple processors in n dimensions including n axes, and temporarily transfer the coefficients to each of the multiple processors based on the first component and the first axis of the coordinates of the mapping indexes. Then, the electronic apparatus 100 may finally transfer the coefficients transferred to each of the multiple processors based on the n-th component and the n-th axis of the coordinates of the mapping indexes.

As an example, FIG. 5 illustrates mapping indexes of coefficients currently stored in each processor. The coordinates of the leftmost processor illustrated in FIG. 5 are (0, 0), and the coordinates of the processors may be set based on the processor having the coordinates (0, 0). The coordinates of the mapping index of the coefficient stored in the processor of (0, 0) may be (0, 3). The electronic apparatus 100 may primarily move the coefficients stored in each processor based on the x-axis component. The processors of the first row (1) store coefficients having the coordinates of the mapping indexes of (0, 3), (1, 1), (2, 1), and (3, 0), respectively. Among the coefficients stored in the processors of the first row (1), the coefficients having the coordinates of the mapping indexes of (3, 0) and (2, 1) should be moved.

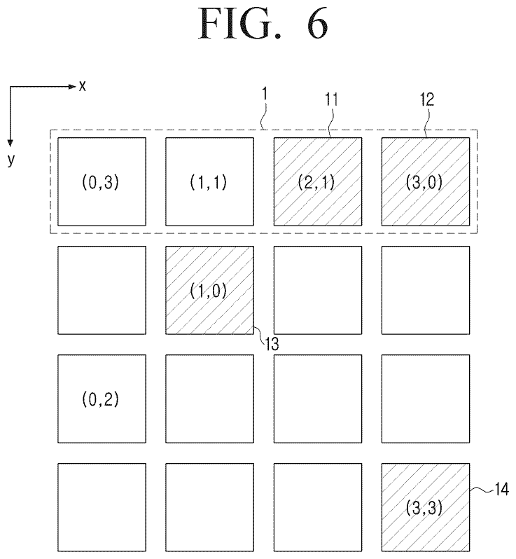

Referring to FIG. 6, a coefficient whose coordinate of the mapping index is (2, 1) may be transferred to a 11th processor 11, and a coefficient whose coordinate of the mapping index is (3, 0) may be transferred to a 12th processor 12. The electronic apparatus 100 may also move coefficients stored in processors of other rows in the same manner. That is, a coefficient whose coordinate of the mapping index is (1, 0) may be transferred to a 13th processor 13, and a coefficient whose coordinate of the mapping index is (3, 3) may be transferred to a 14th processor 14. The electronic apparatus 100 may temporarily move the coefficient only in the x-axis direction based on the x-axis component of the coordinate. When the movement in the x-axis direction is completed, the electronic apparatus 100 may move the coefficient in the y-axis direction based on the y-axis component.

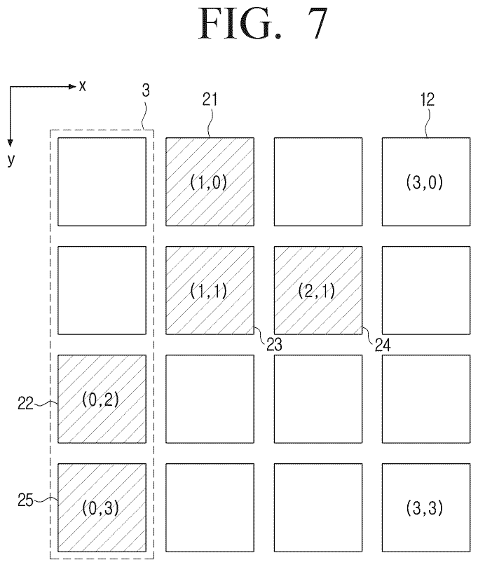

Referring to FIG. 7, the electronic apparatus 100 may move coefficients whose mapping index coordinates are (0, 2) and (0, 3) among the coefficients stored in the processor of the first column (3). Based on the y-axis component of the coordinates, the electronic apparatus 100 may move the coefficient whose coordinates are (0, 2) to a 22nd processor 22 and move the coefficient whose coordinates are (0, 3) to a 25th processor 25. The electronic apparatus 100 may also move coefficients stored in processors of other columns in the same manner. That is, the coefficient whose mapping index coordinates are (1, 0) may be transferred to a 21st processor 21, the coefficient whose mapping index coordinates are (1, 1) may be transferred to a 23rd processor 23, and the coefficient whose mapping index coordinates are (2, 1) may be transferred to a 24th processor 24. The electronic apparatus 100 may finally move the coefficient in the y-axis direction based on the y-axis component of the coordinate. The coefficient moved in the x-axis direction and the y-axis direction may be transferred to the processor corresponding to the final mapping index.

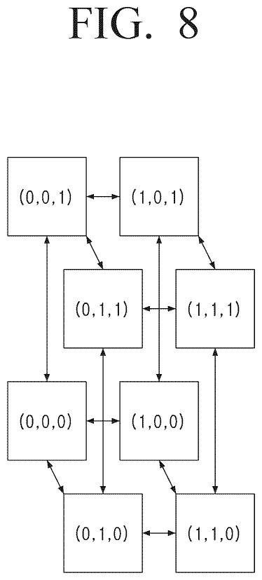

FIGS. 8 to 10 are diagrams for describing a method for allocating coefficients to a three-dimensionally arranged processor according to an embodiment of the present disclosure.

FIG. 8 illustrates an example of a method of arranging processors, in the form of a hypercube. The coordinates illustrated in FIG. 8 may be coordinates of each processor.

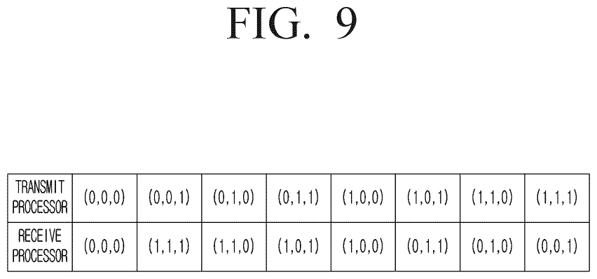

Referring to FIG. 9, the coordinates of the currently stored processor and the coordinates of the final processor corresponding to the mapping index are illustrated. The electronic apparatus may move the coefficients in the x-axis, y-axis, and z-axis directions based on each component of the coordinates similar to the above-described method.

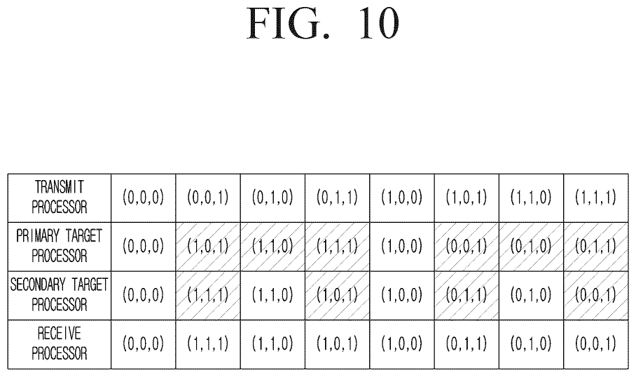

Referring to FIG. 10, the process of moving the coefficients is illustrated. The electronic apparatus 100 may move the coefficient to the hatched processor of the primary target processor based on the x-axis component of the coordinate of the mapping index (the location of the processor to be finally transferred). Then, the electronic apparatus 100 may move the coefficient to the hatched processor of the secondary target processor based on the y-axis component of the coordinate of the mapping index, and then finally move the coefficient to the processor corresponding to the coordinate of the mapping index based on the z-axis component of the mapping index.

The coefficient transfer method of the present disclosure may be identical to the dimension-order routing of the order of x→y→z. In this case, due to the special nature of the data exchange of the automorphism, all paths used for data exchange may not be duplicated.

If there is a duplicated path in the data exchange, the electronic apparatus 100 must share the bandwidth of the duplicated path, which may result in performance degradation. However, the automorphism of the present disclosure guarantees that no path duplication occurs, so that performance degradation does not occur and data may be distributed efficiently.

Meanwhile, the electronic apparatus 100 may access the address actually stored in the memory to retrieve data (coefficient) of a specific index position. The electronic apparatus may calculate an automorphism or for a vector fin a memory address space having a first offset and store or in a memory address space having a second offset. The memory address space having the first offset and the memory address space having the second offset may be address spaces included in physically separate memories, or may be address spaces that are physically included in one memory but logically separated.

For example, the electronic apparatus 100 may determine the address of the coefficient based on the first memory space whose start address is the first offset. Then, the electronic apparatus 100 may determine the storage address of the second memory space whose start address is the second offset based on the determined address-converted mapping index. The electronic apparatus 100 may store the coefficient in the storage address of the determined second memory space.

For example, the electronic apparatus 100 may determine an index i(addr) for a memory space having a start address (addr) as a first offset according to the mapping method. For example, the mapping method may include a method using a modulo operation and a reverse bit method. When the electronic apparatus 100 applies the automorphism σᵣ to f, the electronic apparatus 100 may calculate which index j (mapping index) an element located at an index is moved to and a sign function by the following equation.

$$sgnN ( i ( addr ) \cdot r ) = 1 , {if [ i ( addr ) \cdot r ]}_{2 N} < N$$

$$- 1 , {if [ i ( addr ) \cdot r ]}_{2 N} \geq N$$

$$j = {[ i ( addr ) \cdot r ]}_{N}$$

The electronic apparatus 100 may calculate the memory address addr (j) for a memory space having a second offset. The electronic apparatus 100 may load an element a_{i(addr)} of a vector f stored at a location addr, calculate sgn_{N}(i(addr)·r)·a_{i(addr)}, and then store the calculated sgn_{N}(i(addr)·r)·a_{i(addr)} at a location addr (j). The electronic apparatus 100 may calculate σᵣ through the above-described process.

Meanwhile, the electronic apparatus 100 may calculate the automorphism Tr on a vector f_{NTT} in a memory address space having a first offset, and store τᵣ(f_{NTT}) in a memory address space having a second offset.

The electronic apparatus 100 may determine an index i(addr) for a memory space having a start address (addr) as a first offset in a mapping method. When applying the automorphism tr to f_{NTT}, the electronic apparatus 100 may calculate which index j (mapping index) an element located at an index is moved to by using the following equation.

$$j = ( {[ ( 2 \cdot i ( addr ) + 1 ) \cdot {r}^{- 1} ]}_{2 N} - 1 ) / 2$$

The electronic apparatus 100 may calculate the memory address addr (j) for a memory space having a second offset. The electronic apparatus 100 may retrieve an element a_{i(addr)} of a vector f_{NTT} stored at the addr location and store the retrieved element a_{i(addr)} at the addr (j) location. The electronic apparatus 100 may calculate Tr through the above-described process.

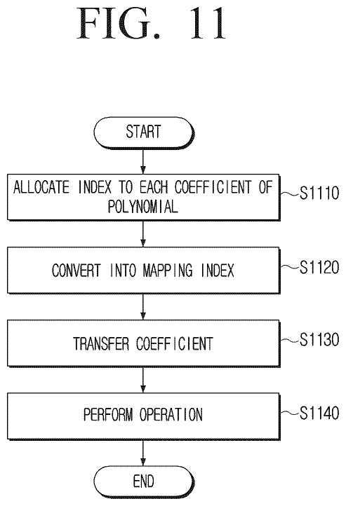

FIG. 11 is a diagram for describing a method for controlling an electronic apparatus according to an embodiment of the present disclosure.

Referring to FIG. 11, the electronic apparatus 100 may allocate an index to each coefficient of the polynomial (S1110). The electronic apparatus 100 may convert the index allocated to each coefficient into the mapping index corresponding to the multiple processors (S1120). For example, the electronic apparatus 100 may convert the index allocated to the coefficient into the mapping index based on the remainder value of the result of the modulo operation for the index allocated to the coefficient according to the preset rotation count and the number of coefficients. Alternatively, the electronic apparatus 100 may determine a value expressed as the reciprocal of the bit of the index allocated to the coefficient as the mapping index. The electronic apparatus 100 may transfer the coefficient to each of the corresponding multiple processors based on the converted mapping index (S1130). When the multiple processors are arranged in one dimension, the electronic apparatus 100 may transfer each coefficient to the corresponding processor based on the mapping index. Alternatively, the electronic apparatus 100 may recognize that the multiple processors are arranged in multiple dimensions. In this case, the electronic apparatus 100 may calculate a coordinate value corresponding to the mapping index. The electronic apparatus 100 may arrange multiple processors in n dimensions including n axes, and temporarily transfer the coefficients to each of the multiple processors based on the first component and the first axis of the coordinates of the mapping indexes. Then, the electronic apparatus 100 may finally transfer the coefficients transferred to each of the multiple processors based on the n-th component and the n-th axis of the coordinates of the mapping indexes.

The electronic apparatus 100 may perform a calculation using the multiple processors based on the transferred coefficients (S1140). For example, the polynomial may include a first polynomial and a second polynomial to perform the operation. The electronic apparatus 100 may perform the operation between coefficients whose mapping indexes of the coefficients included in the first polynomial and mapping indexes of the coefficients included in the second polynomial are the same. In addition, the electronic apparatus 100 may determine the address of the coefficient based on the first memory space whose start address is the first offset. The electronic apparatus 100 may determine the storage address of the second memory space whose start address is the second offset based on the determined address and the converted mapping index. The electronic apparatus may store the coefficient in the storage address of the determined second memory space. The method for controlling the electronic apparatus according to the various embodiments described above may be provided as a computer program product. The computer program product may include a S/W program itself or a non-transitory computer readable medium in which the S/W program is stored.

The non-transitory computer readable medium is not a medium that stores data for a while, such as a register, a cache, a memory, or the like, but means a medium that semi-permanently stores data and is readable by an apparatus. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

In addition, although embodiments of the disclosure have been illustrated and described hereinabove, the disclosure is not limited to the specific embodiments described above, but may be variously modified by those skilled in the art to which the disclosure pertains without departing from the gist of the disclosure as disclosed in the accompanying claims. These modifications are to be understood to fall within the scope and spirit of the disclosure.

1. A method for controlling an electronic apparatus for performing a distributed operation, comprising:
allocating an index to each coefficient of a polynomial;
converting the index allocated to each coefficient into a mapping index corresponding to multiple processors;
transferring the coefficient to each of the corresponding multiple processors based on the converted mapping index; and
performing, by the multiple processors, an operation based on the transferred coefficient.

2. The method as claimed in claim 1, wherein, in the converting of the index into the mapping index, the index allocated to the coefficient is converted into the mapping index based on a remainder value of a result of a modulo operation for the index allocated to the coefficient according to a preset rotation count and the number of coefficients.

3. The method as claimed in claim 1, wherein, in the converting of the index into the mapping index, a value expressed as a bit-reversed value of a bit of the index allocated to the coefficient is determined as the mapping index.

4. The method as claimed in claim 1, wherein, in the transferring, the multiple processors are arranged in an n-dimension including n axes, the coefficient is temporarily transferred to each of the multiple processors based on a first component and a first axis of coordinates of the mapping index, and the coefficient transferred to each of the multiple processors is finally transferred to each of the multiple processors based on an n-th component and an n-th axis of the coordinates of the mapping index.

5. The method as claimed in claim 1, further comprising:
determining an address of the coefficient based on a first memory space whose start address is a first offset;
determining a storage address of a second memory space whose start address is a second offset based on the determined address and the converted mapping index; and
storing the coefficient in the determined storage address of the second memory space.

6. The method as claimed in claim 1, wherein the polynomial includes a first polynomial and a second polynomial to perform an operation.

7. The method as claimed in claim 6, wherein, in the operating, an operation between coefficients whose mapping index of a coefficient included in the first polynomial and mapping index of a coefficient included in the second polynomial are the same is performed.

8. An electronic apparatus, comprising:
a memory; and
a processor,
wherein the processor is configured to allocate an index to each coefficient of a polynomial stored in the memory,
convert the index allocated to each coefficient into a mapping index corresponding to multiple processors,
transfer the coefficient to each of the corresponding multiple processors based on the converted mapping index, and
allow the multiple processors to perform an operation based on the transferred coefficient.

9. The electronic apparatus as claimed in claim 8, wherein the processor is configured to convert the index allocated to the coefficient into the mapping index based on a remainder value of a result of a modulo operation for the index allocated to the coefficient according to a preset rotation count and the number of coefficients.

10. The electronic apparatus as claimed in claim 8, wherein the processor is configured to determine a value expressed as a bit-reversed value of the index allocated to the coefficient as the mapping index.

11. The electronic apparatus as claimed in claim 8, wherein the processor is configured to allow the multiple processors to be arranged in an n-dimension including n axes, temporarily transfer the coefficient to each of the multiple processors based on a first component and a first axis of coordinates of the mapping index, and finally transfer the coefficient transferred to each of the multiple processors to each of the multiple processors based on an n-th component and an n-th axis of the coordinates of the mapping index.

12. The electronic apparatus as claimed in claim 8, wherein the processor is configured to determine an address of the coefficient based on a first memory space whose start address is a first offset, determine a storage address of a second memory space whose start address is a second offset based on the determined address and the converted mapping index, and store the coefficient in the determined storage address of the second memory space.

13. The electronic apparatus as claimed in claim 8, wherein the polynomial includes a first polynomial and a second polynomial to perform an operation.

14. The electronic apparatus as claimed in claim 13, wherein the processor is configured to perform an operation between coefficients whose mapping index of a coefficient included in the first polynomial and mapping index of a coefficient included in the second polynomial are the same.

15. A non-transitory computer-readable storage medium on which a program for executing a method for controlling an electronic apparatus for performing a distributed operation is recorded, wherein the program includes:
allocating an index to each coefficient of a polynomial;
converting the index allocated to each coefficient into a mapping index corresponding to multiple processors;
transferring the coefficient to each of the corresponding multiple processors based on the converted mapping index; and
performing, by the multiple processors, an operation based on the transferred coefficient.
